(19) United States
(12) Patent Application Publication
(10) Pub. No.: US 2002/0075585 A1
(43) Pub. Date: Jun. 20, 2002

(54) Automated drive-level microtrack profile using variable gain amplifier

(76) Inventors: Peter Tri Luong, Singapore (SG); AikChuan Lim, Singapore (SG); Edmun ChianSong Seng, Singapore (SG); UttHeng Kan, Singapore (SG)

Correspondence Address: SCHWEGMAN, LUNDBERG, WOESSNER & KLUTH, P.A., P.O. BOX 2938, MINNEAPOLIS, MN, 55402, US

(21) Appl. No.: 09/965,129

(22) Filed: Sep. 27, 2001

Related U.S. Application Data
(60) Provisional application No. 60/235,590, filed on Sep. 27, 2000.

(51) Int. Cl. G11B 27/36

(52) U.S. Cl. 360/31

(57) ABSTRACT

An information handling system, such as a magnetic disc drive, includes a method and apparatus for performing an onboard microtrack profile test for characterizing the head sensitivity of a magneto-resistive head. The method comprises formation of a very narrow written signal on a track and execution of a microtrack scan based on the count feature from the variable gain amplifier (VGA) from the read channel.

RELATED APPLICATION

This application claims the benefit under 35 U.S.C. 119(e) of U.S. Provisional Application Serial No. 60/235,590, filed Sep. 27, 2000.

### FIELD OF THE INVENTION

The present invention relates in general to information storage systems and in particular to a method and apparatus for implementing the capability of a disc drive to provide an in situ microtrack profile test.

### BACKGROUND OF THE INVENTION

Devices that store data are key components of any computer system. Computer systems have many different devices where data can be stored. One common device for storing massive amounts of computer data is a disc drive. The basic parts of a disc drive are a disc assembly having at least one disc that is rotated, an actuator that moves a transducer to various locations over the rotating disc, and circuitry that is used to write and/or read data to and from the disc via the transducer. The disc drive also includes circuitry for encoding data so that it can be successfully retrieved from and written to the disc surface. A microprocessor controls most of the operations of the disc drive, in addition to passing the data back to the requesting computer and taking data from a requesting computer for storing to the disc.

The disc drive includes a transducer head for writing data onto circular or spiral tracks in a magnetic layer the disc surfaces and for reading the data from the magnetic layer. In some drives, the transducer includes an electrically driven coil (or write head) that provides a magnetic field for writing data, and a magneto-resistive (NMR) element (or read head) that detects changes in the magnetic field along the tracks for reading data.

The transducer is typically placed on a small ceramic block, also referred to as a slider, that is aerodynamically designed so that it flies over the disc. The slider is passed over the disc in a transducing relationship with the disc. Most sliders have an air-bearing surface (ABS) which includes rails and a cavity between the rails. When the disc rotates, air is dragged between the rails and the disc surface causing pressure, which forces the head away from the disc. At the same time, the air rushing past the cavity or depression in the air bearing surface produces a negative pressure area. The negative pressure or suction counteracts the pressure produced at the rails. The slider is also attached to a load spring which produces a force on the slider directed toward the disc surface. The various forces equilibrate so the slider flies over the surface of the disc at a particular desired fly height. The fly height is the distance between the disc surface and the transducing head, which is typically the thickness of the air lubrication film. This film eliminates the friction and resulting wear that would occur if the transducing head and disc were in mechanical contact during disc rotation. In some disc drives, the slider passes through a layer of lubricant rather than flying over the surface of the disc.

Information representative of data is stored on the surface of the storage disc. Disc-drive systems read and write information stored on tracks on storage discs. Transducers, in the form of read/write heads attached to the sliders, located on both sides of the storage disc, read and write information on the storage discs when the transducers are accurately positioned over one of the designated tracks on the surface of the storage disc. The transducer is also said to be moved to a target track. As the storage disc spins and the read/write head is accurately positioned above a target track, the read/write head can store data onto a track by writing information representative of data onto the storage disc. Similarly, reading data on a storage disc is accomplished by positioning the read/write head above a arget track and reading the stored material on the storage disc. To write on or read from different tracks, the read/write head is moved radially across the tracks to a selected target track. The data is divided or grouped together on the tracks. In some disc drives, the tracks are a multiplicity of concentric circular tracks. In other disc drives, a continuous spiral is one track on one side of a disc drive. Servo feedback information is used to accurately locate the transducer. The actuator assembly is moved to the required position and held very accurately during a read or write operation using the servo information.

When a hard disc drive is manufactured, there are a number of recognized proven electrical tests which are employed to characterize magneto-resistive (MR) heads. These electrical tests include measurement of track average amplitude, signal asymmetry, pulse width at half peak level, and overwrite. The performance capabilities of the MR head and any degree of head damage can generally be numerically quantified using these tests. However, a dilemma arises when factory line production test results clearly show that a head clearly passed the electrical parametric tests indicated above but failed for exceeding the error rate limit.

Generally, the only alternative to find out what is wrong with a head is to tear down the drive and have the suspected head part sent for detailed analysis. After this stage, the head will no longer be in use in the disc drive assembly. The head wires are desoldered from the bad head and are then resoldered and reconnected to a separate electrical head tester for spin-stand platform testing. One of the established tests for determining the condition of an MR read element is the microtrack profile.

A microtrack profile is conducted on a test stand separate from a disc drive. The test stand has to be accurate enough to allow writing the track at a precise location every time and repeating the placement of the head at designated locations. To construct microtrack profiles of a transducing head, initially a track is written with a conventional wide-track-width inductive head at a specific radius of the disc. The head is then shifted to another radius, toward, say, the inner diameter of the disc, such that the head track width covers part of the written track and an erase current is applied so that part of the track is erased. Next, the head is moved toward the outer radius of the disc so that, except for a narrow strip, it covers the remaining track. The erase current is then applied, leaving a narrow strip of the written track. The same head, and specifically the read portion of the head, is now shifted over the remaining narrow track for reading. The signal output is read.

The above procedure is repeated by creating the narrow strip at another location along the track. The signal output versus the location of narrow strips is plotted. The microtrack signal is small and requires careful measurements.

The microtrack profile test is very useful in finding defects in a head and specifically the read element of a head that may have a defect yet still pass the electrical parametric tests at manufacture. The microtrack profile test also provides more definitive results with respect to whether a read element is defective or good. Currently, if the read element of a head is tested as good using a microtrack profile test, the head is removed from a disc drive and placed on a separate spin stand. Performing the microtrack profile test now requires the destruction of the disc drive since the disc drive must be torn down to remove the read element to be tested with the microtrack profile test. In addition, conducting a microtrack profile test requires handling by humans and additional, time consuming, process steps.

What is needed is a test such as the microtrack profile test which can be implemented within a disc drive to provide immediate feedback on the condition of the MR element or read element of the head. What is also needed is a test that requires little human intervention and requires no extra hardware. Furthermore, what is also needed is a test that can be conducted at the drive level that eliminates several manufacturing stages including initial testing on a spin stand and removes handling by humans.

### SUMMARY OF THE INVENTION

A disc drive includes a method and apparatus for performing an onboard microtrack profile test for characterizing the head sensitivity of a magneto-resistive head. The method comprises formation of a very narrow written signal on a track and execution of a microtrack scan based on the count feature from the variable gain amplifier (VGA) from the read channel. The method for testing a read element for a disc drive includes producing a test track narrower than the read element on a disc within a disc drive, passing a read element over the test track, and recording an output from a variable gain amplifier. Passing the read element includes shifting the read element 324 with respect to the test track, such as shifting the read element with respect to the test track in a number of discreet steps. The read element is shifted while reading until reading over the test track has been done along the entire length of the test track. The disc drive includes a variable gain amplifier which also includes a register which holds a count value related to the amplification applied to the signal read from a track by the read element. Recording the output further includes recording the count value in the register of the variable gain amplifier. The method may further include holding a read gate associated with the disc drive open when the count values of the register of the variable gain amplifier indicate amplifications near saturation. Producing the narrow test track includes writing a first track with a write head which is wider than the test track. The write head is shifted toward the outer radius such that the write head track width covers a portion of the first track and an erase current is applied to erase a portion of the first track. The write head is also shifted toward the inner radius such that the write head track width covers a portion of the first track and an erase current is applied to erase a portion of the first track and to produce the test track. The test track is written on an area of the disc where there is minimum or substantially zero reader-writer offset. In addition, an area of the disc surface may be erased before writing the first track with a write head.

A disc drive includes a base, at least one disc attached to the base, and an actuator attached to the base. A transducer is attached to the actuator. The actuator positions the transducer to one of a plurality of positions over the at least one disc. The transducer further includes a write element, and a read element. The disc drive also includes a controller capable of performing a test of the read element of the transducer within the disc drive. The controller produces a test track having a width which is less than the width of the read element. The disc drive also includes a read channel which has a variable gain amplifier for amplifying the read signal to a selected level. The controller monitors the amount of gain used to boost the signal to a selected level as an indication of the amplitude of the read signal. The controller performs the test on the read element at selected times over the life of the disc drive including near the time of manufacture of the disc drive. The controller may perform a microtrack profile test on at least one read element in the disc drive while the read element is within the disc drive. The controller searches for a track location where the offset between the read element and the write element of the transducer is substantially zero, and wherein the controller produces a test track having a width which is less than the width of the read element. The controller steps the read element across the test track and determines the amount of gain applied by the variable gain amplifier associated with each track position. The controller analyzes the amount of gain applied by the variable gain amplifier associated with each track position to determine if the read element has a defect. The amplitude of the read signal is related to the amount of gain applied by the variable gain amplifier. The disc drive also includes a memory which is used to store data from a plurality of tests of the read element. In some instances, the controller performs the test as part of failure analysis on a disc drive.

A disc drive includes a base, at least one disc attached to the base, an actuator attached to the base, and a transducer attached to the actuator. The actuator positions the transducer to one of a plurality of positions over the at least one disc. The disc drive also includes a device for checking the transducer within the disc drive. The device for checking the transducer includes a controller for writing a test track narrower than a read element, and moving the read element in a succession of steps over the test track and recording the amplitude of the read signal. The disc drive further includes a read channel. The read channel includes a variable gain amplifier. The controller records the amplitude of the read signal by storing the amount of gain required to boost the read signal to a selected level as part of an automatic gain control associated with the read channel. The device can include a controller for conducting the test within the disc drive at various times during the life of the disc drive. The test conducted, in one embodiment, is a microtrack profile test within the disc drive.

Advantageously, the microtrack profile test is implemented within a disc drive and provides immediate feedback on the condition of the MR element or read element of the transducing head. The test within the disc drive requires little human intervention and requires no additional hardware. Since the test can be conducted at the drive level, several manufacturing stages including initial testing on a spin stand can be eliminated. This also removes several steps requiring handling by humans where there is always a potential for damage.

These and various other features as well as advantages which characterize the present invention will be apparent upon reading of the following detailed description and review of the associated drawings.

### BRIEF DESCRIPTION OF THE DRAWINGS

FIG. 1 is a schematic and block diagram of an information handling system embodying the present invention.

FIG. 2 is a top view of an information handling system embodying the present invention.

FIG. 3 is a schematic diagram of a data channel for use with the information handling system of FIGS. 1 and 2.

FIG. 4 is a schematic diagram of a variable gain amplifier as used in the present invention.

FIG. 5 is a plot of the amplitude of the read signal and the count of the variable gain amplifier verses the bias current of the magneto resistive transducer.

FIG. 6 is a flow diagram of the microtrack profile test procedure performed within a disc drive based on the count or amount of gain applied to the read signal at the variable gain amplifier.

FIG. 7 is a comparative plot of normalized magnitude in amplitude and VGA count against track offset position.

FIG. 8 is a schematic of an information handling system.

### DESCRIPTION OF THE PREFERRED EMBODIMENTS

In the following detailed description of the preferred embodiment, reference is made to the accompanying drawings which form a part hereof, and in which are shown by way of illustration specific embodiments in which the invention may be practiced. It is to be understood that other embodiments may be utilized and structural changes may be made without departing from the scope of the present invention.

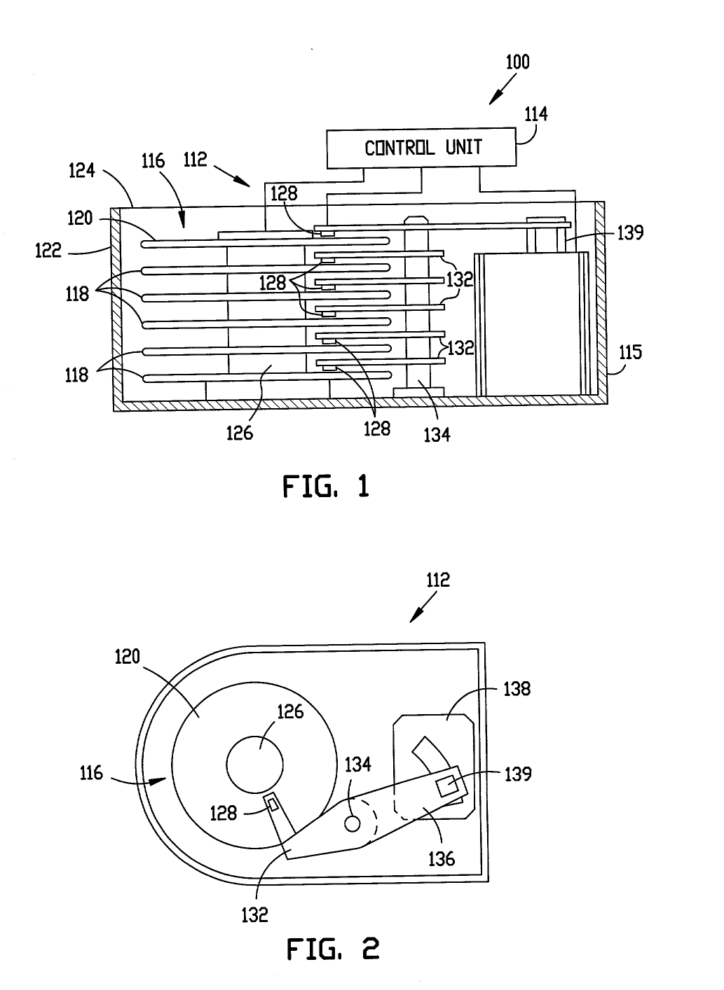

FIG. 1 is a schematic and block diagram of an information handling system embodying the present invention. An information handling system 100, includes a data storage medium 112 and interface control unit 114. In the preferred embodiments of this invention the data storage medium 112 comprises a rigid magnetic disk drive 115, although it should be readily understood that any other mechanically moving memory configuration may be used. The magnetic disk drive 115 is illustrated in simplified form sufficient for an understanding of the present invention. The utility of the present invention is not limited to the details of a particular information handling system or to the specific disk drive shown.

Now referring to both FIGS. 1 and 2 the disk drive 115 portion of the information handling system 100 will be detailed. FIGS. 1 and 2 show the principal electrical and mechanical components of a disk drive 115 constructed in accordance with a preferred embodiment of this invention. The disk drive 115 includes a head/disk assembly, which includes a base 122 and a cover 124. Attached to the base 122 is a spindle with an attached hub 126. Attached to the spindle with an attached hub 126 are a stack 116 of disks 118. It should be noted that some disk drives have a single disk and that this invention is equally applicable to a single disk version of a disk drive. The stack 116 of disks 118 includes at least one magnetic surface 120. Also attached to the base is a spindle motor (not shown) which rotates the spindle with an attached hub 126 and the disks 118 mounted to the hub 126. An actuator 134 includes arms 132 that carry transducers 128 in transducing relation to one of the discs. A portion of an actuator motor 139 is attached to the actuator 132 and positions one or more transducers 128 to different radial positions relative to one or more magnetic surfaces 120 of the disc 118.

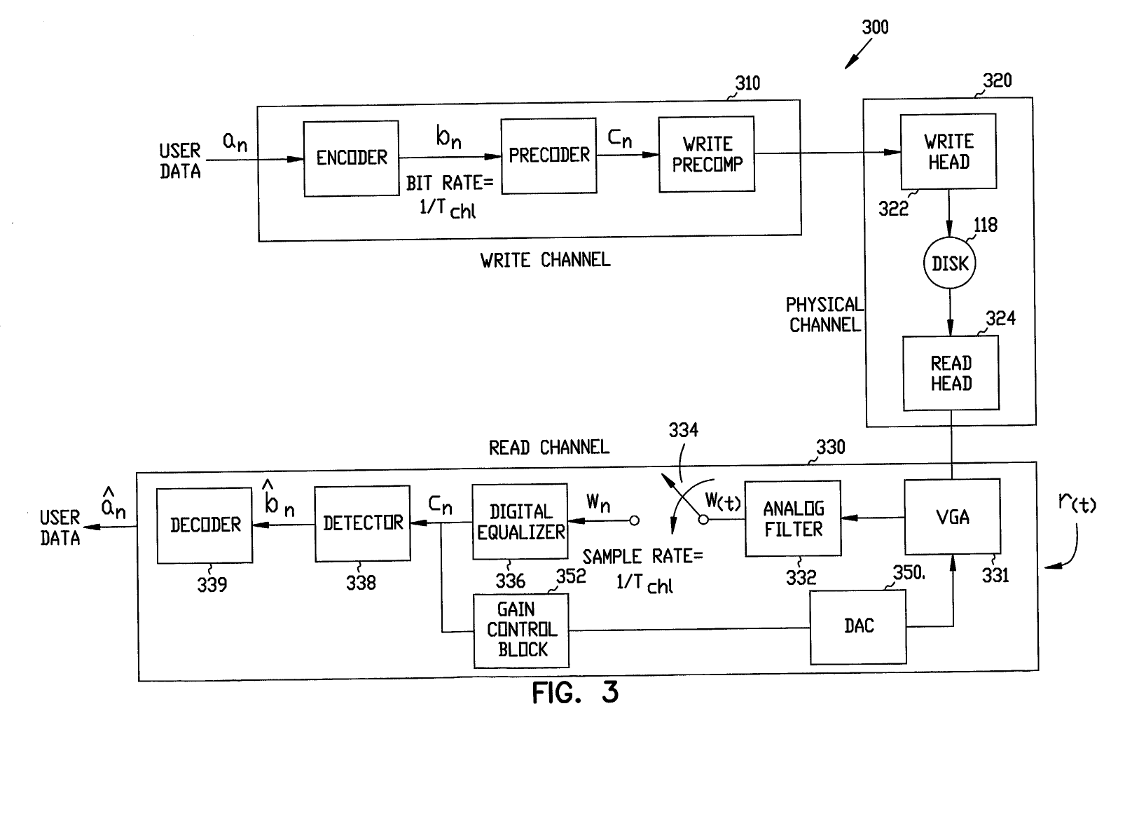

The disc drive 115 also includes a data channel 300. A schematic or block diagram of the data channel 300 is shown in FIG. 3. The data channel 300 includes a write channel 310, a physical channel 320 and a read channel 330. The write channel 310 includes an encoder 312, a precoder 314, and write precompensation circuitry 316. Generally, the encoder 312 and the precoder 344 implement a Maximum Transition Run ( MTR ) code. The particular MTR code used limits the maximum number of consecutive transitions to a selected number. It should be noted that code used is not limited to an MTR code. The precompensation circuitry 316 changes the signal to be written to the disc so that it can be retrieved more easily from the disc by the read head and read channel 330. The physical channel 320 includes a write head 322, a disc 118, and a read head 324. The read head 324 and write head 320 are also known as transducers. In some instances, the read head and the write head may be the same transducer. The write head 322 includes a coil. When a write current is passed through the write head 322 in one direction, the magnetic surface of a disc 118 is magnetized in a first direction. When a write current is passed through the write head 322 in the opposite direction, the magnetic surface of a disc 118 is magnetized in a second direction. Normally, the disc 118 maintains its magnetized state until the area of the disc is rewritten or remagnetized. The read head 324 produces a signal based on the magnetized state of the disc 118 below the read head 324. The signal from the read head 324 is passed into the read channel 330.

The read channel 330 includes a variable gain amplifier 331, a filter 332, a sampler 334, an equalizer 336, a detector 338 and a decoder 339. The read channel also includes a preamplifier 340 generally located as close to the read head 324 as possible. The preamplifier 340 is required to amplify the read head or transducer output to usable levels. After preamplification, a variable gain amplifier ( VGA ) 331 is used as an automatic gain control to boost the read signal to a selected level. The VGA 331 is used as part of automatic gain control. The VGA 331 boosts the signals read from the disc 118 with the read element 324 to a uniform level. The amplitude of the read signal output is used as part of a feedback loop to determine the boost or amplitude to apply to the read signal to boost the signal to a selected level. The filter 332 filters out unwanted portions of the signal from the read head 324. Samples are taken at the sampler 334. The sampled signal is equalized at the equalizer 336. The output of the equalizer 336 is input to a detector 338 which estimates the value of various sampled portions. The output of the detector 338 is passed through a decoder 339 to produce the read back user data. The read channel described above has an analog portion and a digital portion.

The detector 338 is the portion of the read channel that determines if a particular bit has a value of “1”, which indicates a magnetic polarity in a first direction, or a “0”, which indicates a magnetic polarity in a second direction. There are generally two types of detectors. The detector 338 shown in FIG. 3 is known as a sequence detector. Sequence detectors take advantage of the intersymbol interference between terms by examining adjacent samples before making a decision. The Viterbi algorithm (VA) is an efficient means for implementing the maximum likelihood sequence detector (MLSD) which chooses the sequence that most likely produced the received or read signal. A second general type of detector is known as a peak detector. Peak detectors were common in earlier recording systems. In a peak detector, data bits were detected by making a sample-by-sample decisions with a peak detection circuit, which made necessary the use of runlength limited (RLL) codes. The invention is equally applicable to read channels 330 using any type of detector 338.

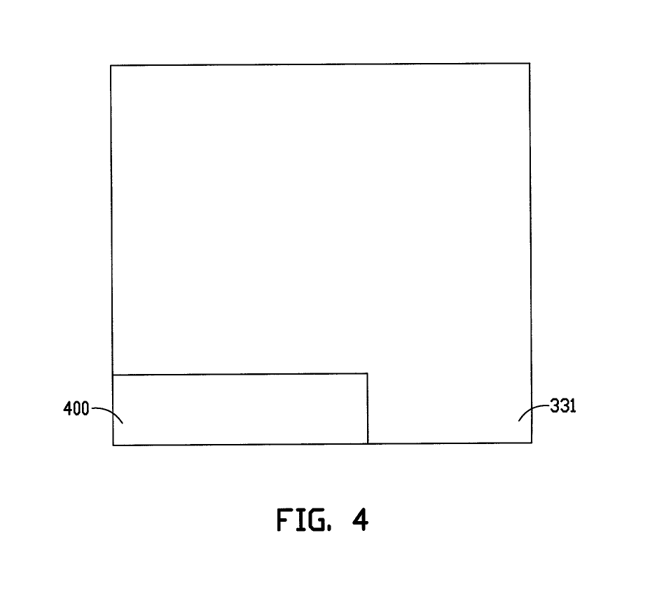

A VGA 331 is a common element in most read channels 330. FIG. 4 shows a schematic diagram of the VGA 331. The VGA 331 includes circuitry for applying an amplification or gain to a read signal. The VGA 331 also includes a register 400 which stores a count value associated with the gain or boost. Any number of values can be designated. In one particular VGA, for example, the register is an eight bit register so that one of 256 count values can be stored in the register 400. Of course other numbers of count values may also be used. The count value is used to determine the amount of gain that is to be applied to the read signal from the read channel to produce a signal having a selected level. The amount of boost or gain applied to the read signal is directly proportional to the amplitude of the read signal. For example, when the read element 324 is positioned over the track center, less gain is required to read the signal since the amplitude is high. Conversely, greater gain adjustment would be needed near the track boundary since the signal amplitude would be less.

The method for performing a microtrack profile test at the disc drive level without any hardware extension is to utilize the variable gain amplifier (VGA) count feature of the variable gain amplifier 331 to represent amplitude of the read signal. The principle behind this is that on track center, less gain would be required to read the signal since the amplitude is high. Conversely, greater gain adjustment would be needed at near track boundary read of lesser signal amplitude. Therefore, an extensive study was undertaken to prove if amplitude correlates well with the VGA count.

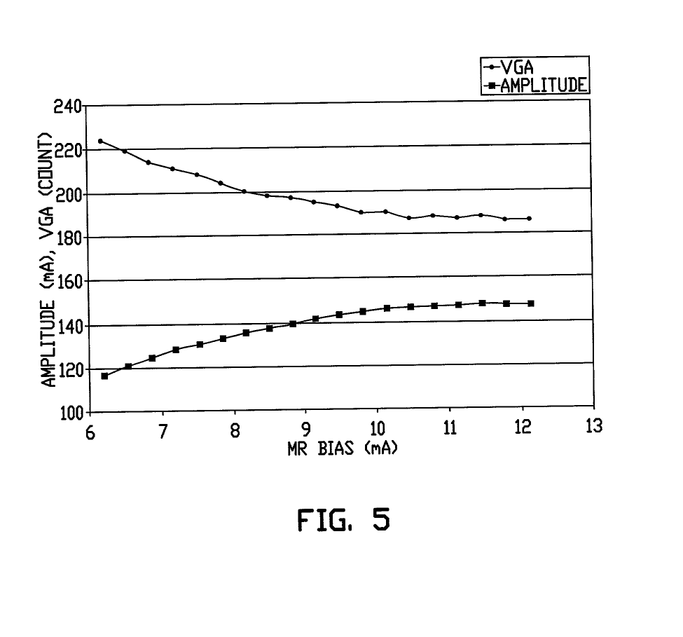

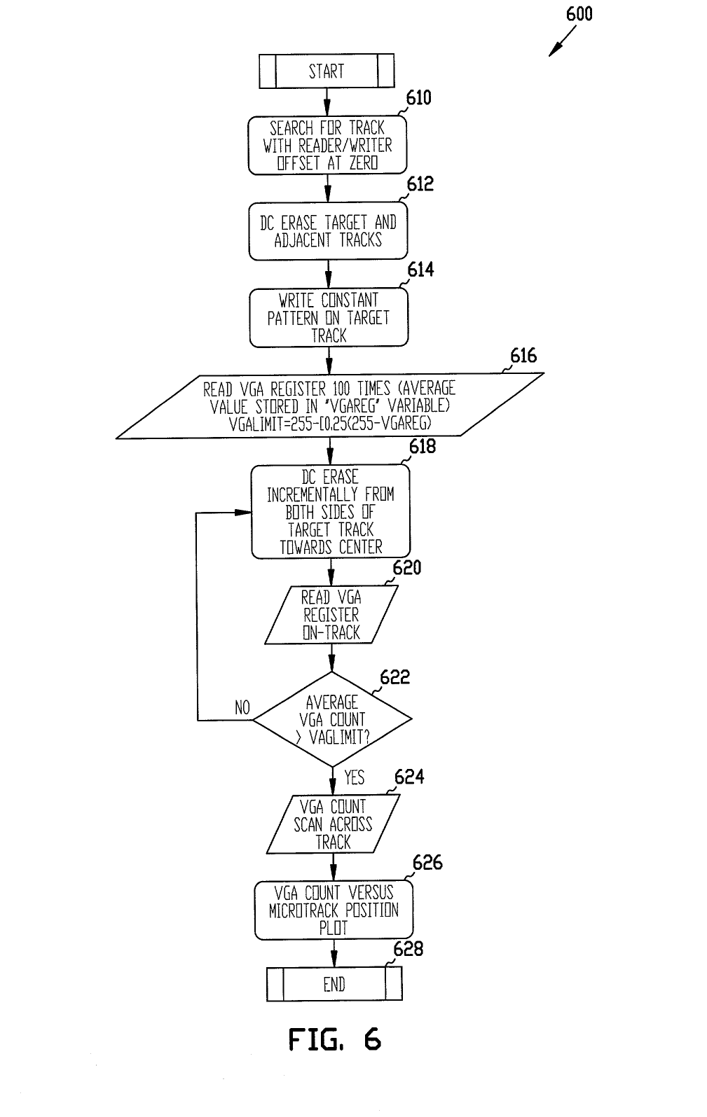

FIG. 5 is a plot of the amplitude of the read signal and the count of the variable gain amplifier versus the bias current of the magneto-resistive head. FIG. 5 shows the method of realizing the correlation which is to vary the MR bias current and to observe the amplitude of the read signal as well as the value in the VGA count register 400 of the VGA 331. Basically, varying the bias current manipulates the electrical response in the MR head in terms of signal amplitude. The procedure involves stepping through the bias current and simultaneously measuring the track average amplitude (TAA) along with extracting the VGA 331 count value from the read channel register 400. The end result illustrated a direct translation in amplitude to VGA count values verses bias current setting as shown in FIG. 5. As a result, a microtrack profile test may be successfully executed at the drive level by using VGA count from register 400 in place of amplitude measurement.

The VGA count is an eight-bit value, read from the read channel s VGA register. Zero VGA count means that gain is not required, whereas maximum 255 counts represent highest gain applied. During the VGA count acquisition, read gate of the read counter had to be forcefully asserted. If the read gate is not forcefully asserted, the controller 114 will halt the read operation and report a read error condition when VGA counts are high or near saturation. Normally a bad head will have a higher than expected VGA count, thus limiting the dynamic operating range. Therefore, the test had to ensure adequate VGA range for measurement and yet maintain the narrow written band for precise microtrack profiling.

FIG. 6 is a flow diagram of the microtrack profile test procedure performed within the disc drive based on the count in a register 400. The count in the register 400 of the VGA 331 correlates to the amount of gain applied to the read signal by the VGA 331. The procedure is set forth as procedure 600 in FIG. 6. It should be noted that a number of preconditions are generally required to obtain an accurate test using the microtrack profile procedure. One of the preconditions is to locate a track with the offset between the read element 324 and the write element 322 is at or near zero. In other words, a track is located where there is minimum reader-to-writer offset at that particular track. The reason for this is to center the profile and for fitting a full head response within the track window. So initially, a search is conducted for a track with a reader-writer offset at or near zero, as depicted by reference numeral 610. Once this particular track is found, the full track width is read to determine if it has an acceptable VGA 331 count at a full track read to maintain an adequate signal level. Yet another precondition is that the position error signal must be fairly stable for the particular track selected. This assures that the read element and write element will not have to be corrected excessively during the procedure. Such corrections can lead to differing results in the microtrack test procedure since it is absolutely critical that the read element be held steady with respect to a microtrack. The final precondition is that a servo linearization be performed on the test head since accurate head positioning is also dependent on this calibration. After the preconditions are met and a target track is selected with a reader-writer offset either at zero or substantially zero, the target track and several adjacent tracks on either side of the target track are DC erased, as depicted by reference numeral 612. The write head is then repositioned over the target track area and a constant pattern is written at the target track, as depicted by reference numeral 614. The VGA register 400 is then read a multiple number of times while the write head is positioned over the constant pattern written on the track. This yields an average value at the VGA register. Also, a VGA limit is set that is at 75% of the upper limit of the count value plus 25% of the VGAREG value or the average VGA read at the target track, as depicted by reference numeral 616. The next step is to DC erase incrementally from both sides of the target track toward the center of the target track, as depicted by reference numeral 618. After performing a DC erase on both sides of the target track, the VGA register 400 is read on track, as depicted by reference numeral 620. A VGA count average is then determined and compared to the VGA limit. If the VGA count is not greater than the VGA limit, then the steps 618 and 620 are repeated. Namely, another DC erase incrementally from both sides of the target track toward the center is conducted to make for a thinner track and the read VGA register on track is then monitored and the average VGA count is then compared to the VGA limit until the VGA count is greater than the VGA limit. When the VGA count is greater than the VGA limit, a VGA count is made while the read head is scanned across the track, as depicted by reference numeral 624. In other words, the read element 324 is stepped across the resulting target track and the VGA count is monitored at each of the positions of the read element as it is stepped across the target track. A plot is then made of the VGA count versus the microtrack position, as depicted by reference numeral 626.

An experiment was performed to demonstrate the accuracy of the method of microtrack profiling on a disc drive using the VGA count feature in comparison to the spin-stand method. The spin-stand method is the controlled part of the experiment. Both of these methods were applied on a specific disc. The chosen physical target track was selected with the least reader-writer offset. A good head (physical head 1) and a suspected bad head (physical head 11) were selected for the head characterization. The head that was suspected to be bad was originally failed in the test process line due to poor error rate performance. However, electrical parametric test data indicated that it was comparable to a good head in magnitude.

Initially, an extraction of the microtrack profile was performed on a drive applying the same method used in spin-stand electrical test. The limit imposed on the incremental DC erasure to 25% of the starting amplitude is somewhat arbitrary. The idea is to have the narrowest track possible and yet maintain adequate signal-to-noise to still measure a good profile. The amplitude is extracted by probing the differential read signals after the pre-amplifier. The readings were tabulated for every step interval offset across a track. The resolution of the profile is directly dependent on the step offset size.

A microtrack profile test procedure was then executed whereby the measurements were based on VGA count from register 400. Variable VGAREG is defined as the starting VGA count reading. Variable VGALIMIT is defined as the difference of the maximum or worst VGA count (i.e., 255) to the 25 percentile of the available VGA dynamic range.

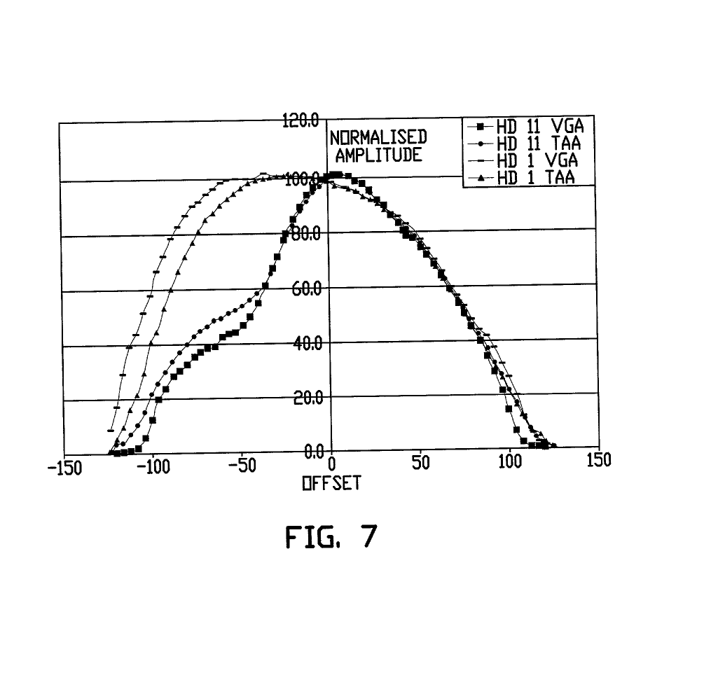

Finally, the two profiles were normalized in magnitude for comparative study. The purpose was to define the shape of the profile to determine an abnormal type from another. FIG. 7 shows the combined profiles. Good and bad heads are referenced as head 1 and 11, respectively. Note the profile of the good head as extracted by the VGA count method matches with the known traditional method. Similarly, the profiles of the bad head show near exact resemblance between the two methods. Therefore, the microtrack profilings by amplitude and VGA count were well correlated.

By observation, a good linear response of the MR reader is indicated by its near symmetrical inverted parabola shape. The flat part of the profile can be attributed to a portion of the MR sensor that has been damaged and is not producing a response. This can be due either to mechanical damage (e.g., scratch) or perhaps damage from an electrostatic discharge or EOS event.

Using the method described, the microtrack profile test can now be conducted within the disc drive without having additional equipment needed or without additional equipment extension. This provides for several advantages. Among the advantages are that the microtrack profile test can now be added to a battery of tests that can be performed at any time with respect to the life of the disc drive. For example, microtrack profiling can be done at the time of manufacture to further test the various transducers or can be done after an event which might affect the transducers such as an electrostatic discharge event. The data from each of these tests can be stored in memory for future reference, for example, at the time of failure analysis, the test results can be reviewed to determine if or when a head went bad. There are still further possibilities, for example, that the heads can be tested as a part of failure analysis. Yet another possibility is that the head can be removed from service when it is found to have degraded so that no further information is written underneath a bad head or a head that fails a microtrack profiling test. In the case of finding a bad head or one that is degrading, the information written to the surface below the particular head going bad can be removed and placed on other surfaces within the disc drive or can be placed upon another recording area if the drive should be mirrored or part of a raid system.

Yet a further advantage is that the controller 114 can be used to determine if the head is bad. The data from the VGA count register 400 can be analyzed to determine if the shape of the data is irregular such as that shown in FIG. 7, thereby indicating a bad head. The controller 114 would not have to formulate or plot the data but could merely attempt to fit a parabola or a functional curve to the data and note a variation between the ideal data represented more or less by a parabola and the data on a bad head. This could then be used to determine the goodness or badness of a head and, therefore, be used to fail a particular read transducer.

Advantageously, the microtrack profile test is implemented within a disc drive and provides immediate feedback on the condition of the MR element or read element of the transducing head. The test within the disc drive requires little human intervention and requires no additional hardware. Since the test can be conducted at the drive level, several manufacturing stages including initial testing on a spin stand can be eliminated. This also removes several steps requiring handling by humans where there is always a potential for damage.

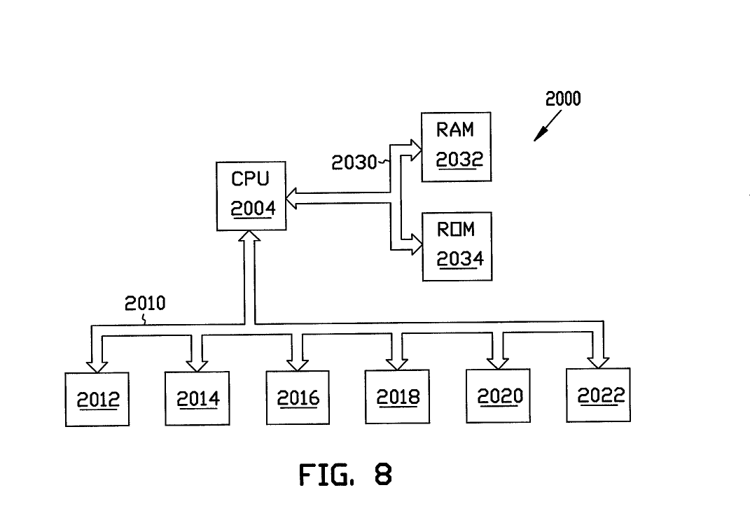

FIG. 8 is a schematic view of a computer system. Advantageously, the invention is well-suited for use in a computer system 2000. The computer system 2000 may also be called an electronic system or an information handling system and includes a central processing unit, a memory and a system bus. The information handling system includes a central processing unit 2004, a random access memory 2032, and a system bus 2030 for communicatively coupling the central processing unit 2004 and the random access memory 2032. The information handling system 2002 includes a disc drive device described above. The information handling system 2002 may also include an input/output bus 2010 and several devices peripheral devices, such as 2012, 2014, 2016, 2018, 2020, and 2022 may be attached to the input output bus 2010. Peripheral devices may include hard disc drives, magneto optical drives, floppy disc drives, monitors, keyboards and other such peripherals.

Conclusion

A method for testing a read element for a disc drive includes producing a test track narrower than the read element on a disc within a disc drive, passing a read element over the test track, and recording an output from a variable gain amplifier. Passing the read element includes shifting the read element 324 with respect to the test track, such as shifting the read element with respect to the test track in a number of discreet steps. The read element is shifted while reading until reading over the test track has been done along the entire length of the read element 324. The disc drive includes a variable gain amplifier which also includes a register which holds a count value related to the amplification applied to the signal read from a track by the read element. Recording the output further includes recording the count value in the register of the variable gain amplifier. The method may further include holding a read gate associated with the disc drive open when the count values of the register of the variable gain amplifier indicate amplifications near saturation. Producing the narrow test track includes writing a first track with a write head which is wider than the test track. The write head is shifted toward the outer radius such that the write head track width covers a portion of the first track and an erase current is applied to erase a portion of the first track. The write head is also shifted toward the inner radius such that the write head track width covers a portion of the first track and an erase current is applied to erase a portion of the first track and to produce the test track. The test track is written on an area of the disc where there is minimum or substantially zero reader-writer offset. In addition, an area of the disc surface may be erased before writing the first track with a write head.

A disc drive includes a base, at least one disc attached to the base, and an actuator attached to the base. A transducer is attached to the actuator. The actuator positions the transducer to one of a plurality of positions over the at least one disc. The transducer further includes a write element, and a read element. The disc drive also includes a controller capable of performing a test of the read element of the transducer within the disc drive. The controller produces a test track having a width which is less than the width of the read element. The disc drive also includes a read channel which has a variable gain amplifier for amplifying the read signal to a selected level. The controller monitors the amount of gain used to boost the signal to a selected level as an indication of the amplitude of the read signal. The controller performs the test on the read element at selected times over the life of the disc drive including near the time of manufacture of the disc drive. The controller may perform a microtrack profile test on at least one read element in the disc drive while the read element is within the disc drive. The controller searches for a track location where the offset between the read element and the write element of the transducer is substantially zero, and wherein the controller produces a test track having a width which is less than the width of the read element. The controller steps the read element across the test track and determines the amount of gain applied by the variable gain amplifier associated with each track position. The controller analyzes the amount of gain applied by the variable gain amplifier associated with each track position to determine if the read element has a defect. The amplitude of the read signal is related to the amount of gain applied by the variable gain amplifier. The disc drive also includes a memory which is used to store data from a plurality of tests of the read element. In some instances, the controller performs the test as part of failure analysis on a disc drive.

A disc drive includes a base, at least one disc attached to the base, an actuator attached to the base, and a transducer attached to the actuator. The actuator positions the transducer to one of a plurality of positions over the at least one disc. The disc drive also includes a device for checking the transducer within the disc drive. The device for checking the transducer includes a controller for writing a test track narrower than a read element, and moving the read element in a succession of steps over the test track and recording the amplitude of the read signal. The disc drive further includes a read channel. The read channel includes a variable gain amplifier. The controller records the amplitude of the read signal by storing the amount of gain required to boost the read signal to a selected level as part of an automatic gain control associated with the read channel. The device can include a controller for conducting the test within the disc drive at various times during the life of the disc drive. The test conducted, in one embodiment, is a microtrack profile test within the disc drive.

It is to be understood that even though numerous characteristics and advantages of various embodiments of the present invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application for the detector while maintaining substantially the same functionality without departing from the scope and spirit of the present invention. In addition, although the preferred embodiment described herein is directed to a detector for a information storage system, it will be appreciated by those skilled in the art that the teachings of the present invention can be applied to other systems, such as communications or other systems, without departing from the scope and spirit of the present invention. Many other embodiments will be apparent to those of skill in the art upon reviewing the above description. The scope of the invention should, therefore, be determined with reference to the appended claims, along with the full scope of equivalents to which such claims are entitled.

What is claimed is:

1. A method for testing a read element for a disc drive, said method comprising the steps of:
(1) producing a test track narrower than the read element on a disc within a disc drive;
(2) passing a read element over the test track; and
(3) recording an output from a variable gain amplifier.

2. The method for testing a read element for a disc drive of claim 1, wherein the passing the read element step (b) further comprises the step of (b)(i) shifting the read element with respect to the test track.

3. The method for testing a read element for a disc drive of claim 1, wherein the passing the read element step (b) further comprises the step of (b)(i) shifting the read element with respect to the test track occurs in discreet steps.

4. The method for testing a read element for a disc drive of claim 3, wherein the shifting step (b)(i) further comprises reading with the read element along the entire length of the read element.

5. The method for testing a read element for a disc drive of claim 1, wherein the variable gain amplifier includes a register which holds a count value related to the amplification applied to the signal read from a track by the read element and wherein the output recording step (c) further comprises recording the count value in the register of the variable gain amplifier.

6. The method for testing a read element for a disc drive claim 5 further comprising the step of (d) holding a read gate associated with the disc drive open when the count values of the register of the variable gain amplifier indicate amplifications near saturation.

7. The method for testing a read element for a disc drive of claim 1, wherein the test track producing step (a) further comprises the steps of:
(a)(i) writing a first track with a write head, the first track being wider than the test track;
(a)(ii) shifting the write head toward the outer radius such that the write head track width covers a portion of the first track and applying an erase current to erase a portion of the first track; and
(a)(iii) shifting the write head toward the inner radius such that the write head track width covers a portion of the first track and applying an erase current to erase a portion of the first track to produce the test track.

8. The method for testing a read element for a disc drive of claim 7, wherein the test track producing step (a) further comprises the step of (a)(iv) locating a track having a minimum reader-writer offset.

9. The method for testing a read element for a disc drive of claim 7, wherein the test track producing step (a) further comprises the step of (a) (iv) locating a track having substantially zero reader-writer offset.

10. The method for testing a read element for a disc drive of claim 1, wherein the test track producing step (a) further comprises the steps of:
(a)(i) erasing an area of the disc surface;
(a)(ii) writing a first track with a write head, the first track being wider than the test track;
(a)(iii) shifting the write head toward the outer radius such that the write head track width covers a portion of the first track and applying an erase current to erase a portion of the first track; and
(a)(iv) shifting the write head toward the inner radius such that the write head track width covers a portion of the first track and applying an erase current to erase a portion of the first track to produce the test track.

11. A disc drive comprising:
a base;
at least one disc attached to the base;
an actuator attached to the base;
a transducer attached to the actuator, the actuator positioning the transducer to one of a plurality of positions over the at least one disc, the transducer further comprising:
a write element; and
a read element; and
a controller capable of performing a test of the read element of the transducer within the disc drive.

12. The disc drive of claim 11 wherein the controller produces a test track having a width which is less than the width of the read element.

13. The disc drive of claim 11 wherein the disc drive is further comprised of a read channel which includes a variable gain amplifier for amplifying the read signal to a selected level, the controller monitoring the amount of gain used to boost the signal to a selected level as an indication of the amplitude of the read signal.

14. The disc drive of claim 11 wherein the controller performs the test on the read element at selected times over the life of the disc drive.

15. The disc drive of claim 14 wherein the controller performs the test on the read element near the time of manufacture of the disc drive.

16. The disc drive of claim 11 wherein the controller performs a microtrack profile test on at least one read element in the disc drive while the read element is within the disc drive.

17. The disc drive of claim 11 wherein the controller searches for a track location where the offset between the read element and the write element of the transducer is substantially zero, and wherein the controller produces a test track having a width which is less than the width of the read element.

18. The disc drive of claim 17 wherein the controller steps the read element across the test track and determines the amount of gain applied by the variable gain amplifier associated with each track position.

19. The disc drive of claim 18 wherein the controller analyses amount of gain applied by the variable gain amplifier associated with each track position to determine if the read element has a defect.

20. The disc drive of claim 18 wherein the controller analyses amplitude of the read signal as it relates to the amount of gain applied by the variable gain amplifier associated with each track position to reject the transducer.

21. The disc drive of claim 14 wherein the disc drive further includes memory, the memory storing data from a plurality of tests of the read element.

22. The disc drive of claim 14 wherein the controller performs the test as part of failure analysis on a disc drive.

23. A disc drive comprising:
a base;
at least one disc attached to the base;
an actuator attached to the base;
a transducer attached to the actuator, the actuator positioning the transducer to one of a plurality of positions over the at least one disc;
means for checking the transducer within the disc drive.

24. The disc drive of claim 23 wherein the means for checking the transducer includes a controller for
writing a test track narrower than a read element; and
moving the read element in a succession of steps over the test track and recording the amplitude of the read signal.

25. The disc drive of claim 24 wherein the disc drive further includes a read channel including a variable gain amplifier, wherein the controller records the amplitude of the read signal by storing the amount of gain required to boost the read signal to a selected level as part of an automatic gain control associated with the read channel.

26. The disc drive of claim 23 wherein the means for checking the transducer includes a controller for conducting the test within the disc drive at various times during the life of the disc drive.

27. The disc drive of claim 23 wherein the means for checking the transducer includes a controller which conducts a microtrack profile test within the disc drive.
